(19) United States
(12) Patent Application Publication
(10) Pub. No.: US 2026/0285130 A1
(43) Pub. Date: Sep. 24, 2026

(54) Enclosure for Thermal Management Module

(71) Applicant: MAHLE INTERNATIONAL GMBH, Stuttgart (DE)

(72) Inventors: Ann-Kathrin HAAG, Stuttgart (DE); Mark James ZIMA, Stuttgart (DE); Karim-Mathieu BOUCHALAT, Stuttgart (DE); Holger STRIEGE, Stuttgart (DE); Hannes STADLER, Stuttgart (DE)

(21) Appl. No.: 19/386,773

(22) Filed: Nov. 12, 2025

Related U.S. Application Data
(60) Provisional application No. 63/775,914, filed on Mar. 21, 2025.

(51) Int. Cl. B60H 1/32; F24F 13/22

(52) U.S. Cl. CPC B60H 1/3233; F24F 13/222

(57) ABSTRACT

A thermal management module system is provided and includes a thermal management module and an enclosure that surrounds the thermal management module. The enclosure includes a connection for a drainage path that leads from a space within the enclosure. A discharge conduit is fluidly connected to the connection and extends away from the enclosure, wherein the connection is arranged such that liquid or fluid or refrigerant that is heavier than air that exists outside of the thermal management module and within the enclosure can flow through the connection. A suction source that is disposed in communication with the discharge conduit.

### CROSS-REFERENCE TO RELATED APPLICATIONS

This application claims priority from U.S. Provisional Patent Application No. 63/775,914, filed on Mar. 21, 2025, the entirety of which is hereby incorporated by reference herein.

### BACKGROUND OF THE INVENTION

Thermal management modules are modules that include all or a significant portion of the components within a refrigeration system that are fixed together. Thermal management modules are connected as a single unit such that the thermal management module can be installed within a vehicle or machine that will include HVAC functionality as a single installation step.

### SUMMARY OF THE INVENTION

A first representative embodiment of the disclosure is provided. The embodiment includes a thermal management module system. The system includes
a thermal management module and an enclosure that surrounds the thermal management module,
wherein the enclosure comprises a connection for a drainage path that leads from a space within the enclosure, and a discharge conduit that is fluidly connected to the connection and extends away from the enclosure, wherein the connection is arranged such that liquid that exists outside of the thermal management module and within the enclosure can flow through the connection;
further comprising a suction source that is disposed in communication with the discharge conduit.

Other representative embodiments of the disclosure are commiserate with the scope of Numbered Paragraphs 1-43 at the end of the specification as well as various combinations of those Numbered Paragraphs.

The disclosure includes representative embodiments that are commiserate with the scope of the Numbered Paragraphs provided at the conclusion of the specification below, as well as combinations of those Numbered Paragraphs.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a side schematic view of an enclosure for a thermal management module and a discharge path therefrom that establishes a suction to pull air and liquid (which may be liquid or refrigerant in other phases) from within the enclosure.

FIG. 2 is a side schematic view of another embodiment of an enclosure for a thermal management module and a discharge path therefrom that establishes a suction to pull air and liquid from within the enclosure.

FIG. 2A is a view like FIG. 2 but where two discharge paths are provided that extend from different positions of the enclosure for redundancy in case of partial or full blockage of one of the discharge paths.

FIG. 3 is a perspective view of a portion of the enclosure for the embodiments of FIG. 1 or FIG. 2.

FIG. 4 is a schematic view of a portion of a vehicle that includes the enclosure thermal management module of FIGS. 1-3.

### DETAILED DESCRIPTION OF THE INVENTION

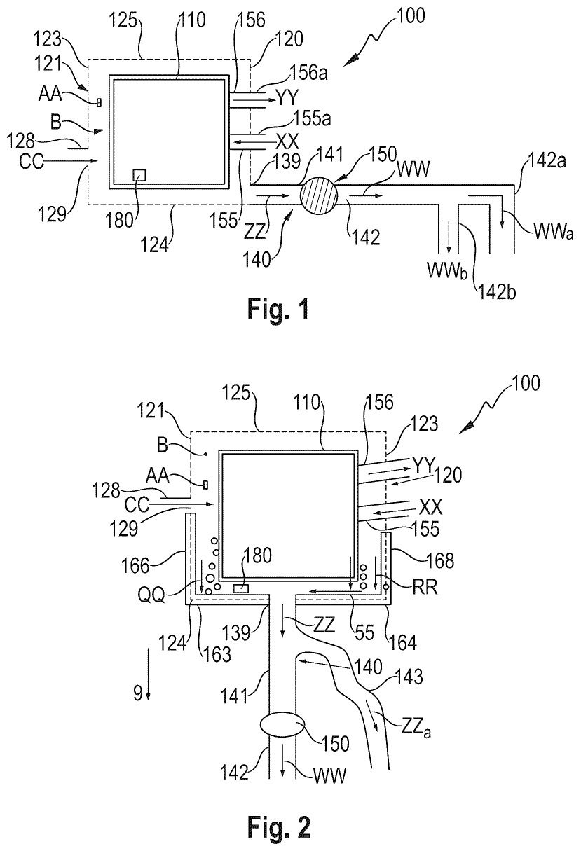

Turning now to FIGS. 1-4, a thermal management module system 100 is provided. The thermal management module system 100 is specifically be configured to be installed within a vehicle (such as a passenger vehicle or passenger truck) to be used in the functionality of the vehicle, such as with a coolant system for a vehicle, such as an battery electric vehicle (BEV). The thermal management module system 100 could be alternatively provided within other vehicles such as busses, construction equipment, farm equipment, military vehicles, trains, ships, aircraft, cranes, or the like. The thermal management module system 100 is described herein for use in a passenger vehicle, but one of ordinary skill in the art with a thorough review of this specification would readily understand how the system 100 may be used in other vehicles or equipment and implement in those with merely routine optimization.

FIG. 1 is a schematic view of a thermal management module system 100. The system 100 includes a thermal management module 110 that is disposed within an enclosure 120. The thermal management module 110 may be a unitary refrigeration system that includes all components of a typical (or specific) refrigeration system within the enclosure 120 (such as compressor, condenser, expansion valve, and evaporator, or other components that are used to achieve the desired thermal process or environment within the thermal management module 110) such that the enclosure is constructed to receive an inlet of flow (liquid or gas) (XX through inlet 155) that is to be cooled within the thermal management module 110 and an outlet of flow (liquid or gas) (YY through outlet 156). Other inlet and outlets as necessitated or desired may be provided with the thermal management module 110.

The enclosure 120 forms a barrier outside of the components of the thermal management module 110. The enclosure includes apertures for the inlet 155 (aperture 155a), and the outlet 156 (aperture 156a) (as well as apertures to provide for other needed or desired inlets or outlets for the operation of the thermal management module), and includes the connection 139 as discussed herein, but does not include other openings to allow substantial flow into or out of the inner volume B within the enclosure 120. The enclosure also includes apertures (not shown) for electrical power and control/communication signals to flow to the thermal management module (not shown). In some embodiments, the enclosure 120 may include a closable aperture, or may be able to be disassembled or opened, to allow for maintenance or replacement of the thermal management module 110, such as to allow for recharging the refrigerant within the thermal management module or to replace one or more components therein.

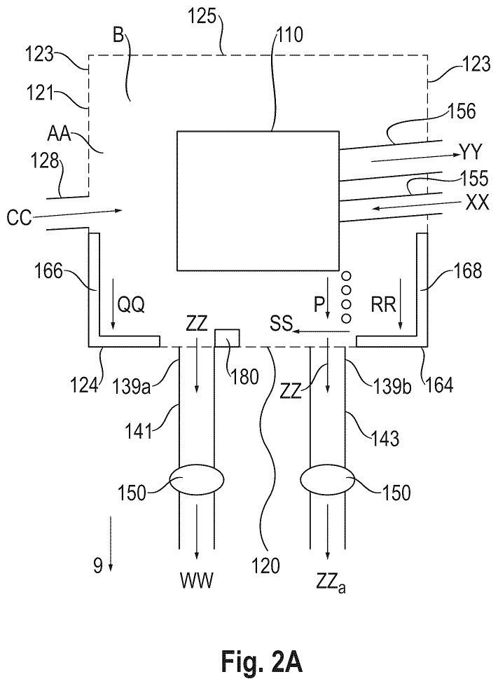

In some embodiments, the enclosure 120 is formed to generally prevent gas (e.g. air, or other gasses) or liquids to flow into the thermal management module 110 from the environment outside of the enclosure—i.e. from within an engine space for vehicles with an internal combustion engine, or from within a mechanical space that holds the enclosure for BEVs. In a preferred embodiment, the enclosure 120 is configured to allow dedicated inflow of air into the inner volume B (flow CC) that provides a continuous flow of air to be pulled (vacuum dragged) out of the enclosure through the connection 139 and the discharge conduit 140, as discussed above. In FIGS. 1 and 2 the enclosure 120 is schematically drawn with broken lines to visually depict that the enclosure is configured to allow a dedicated inflow therethrough and into the inner volume (depicted schematically as flow CC), but in preferred embodiments, the overwhelming majority of the surface of the enclosure 120 does not allow air flow therethrough and one or more dedicated openings 129 are provided. The dedicated opening(s) 129 are provided upon the enclosure 120 and is preferably located in a position upon the enclosure 120 to allow the needed volume of air (CC) to flow into the inner volume B that satisfies the vacuum drawn by the suction source (150, discussed below) but prevents or substantially prevents liquid from flowing into the inner volume B. For example, the opening 129 may be disposed below a roof 128 or other structure that would prevent liquid from above (and in some embodiments from the side) from flowing through the opening. The opening 129 may be provided after a tortuous path formed by structures of the enclosure 120 (or in other embodiments a combination of structures of the enclosure 120 and dedicated structures of other components fixed next to the enclosure 120) that allows the needed amount of air flow therethrough (based upon the air pressure within the space that receives the system 10, which may be atmospheric pressure or slightly above atmospheric pressure during vehicle operation) and into the inner volume B (air flow CC) but prevents or substantially prevents liquid to flow therethrough and into the inner volume B.

The enclosure includes a connection 139 that is fixed to the enclosure and allows for liquid and gas (as well as refrigerants in its phase such as propane as discussed below) to flow therethrough leave the inner volume B of the enclosure (air flow ZZ). A discharge conduit 140 is fixed to the connection 139 and receives and directs the air that flows out of the enclosure through the connection 139. In some embodiments depicted in FIG. 2, the connection 139 is disposed proximate to a geometric center of the enclosure 120 that is projected upon an outlet surface, or the connection may be disposed at the geometric center of the of the enclosure 120 that is projected upon an outlet surface. The outlet surface may be the bottom wall 124 of the enclosure 120, while in other embodiments, particularly where the enclosure does not include a planar or otherwise bottom wall, the outlet surface may be a nonplanar surface that is partially or totally vertically below the module 110. In some embodiments depicted in FIG. 2A, the connection 139 may be different first and second connections 139a, 139b that are located in separate positions upon the enclosure, such that blockage of one of the first or second connection 139a, 139b does not prevent or minimize flow from the enclosure through the other connection 139a, 139b. Each connection 139a, 139b may be connected with a respective independent discharge conduit 141, 143 (like FIG. 2 but with the second discharge conduit 143 extending to a connection 139b that is at a different location from the sole connection 139 depicted in the figure. Both connections 139a, 139b may be disposed upon a bottom portion of the enclosure 120 and at an end of a flow channel such that flow through a respective flow channel is urged into a respective connection 139a, 139b.

A suction source 150 is disposed in fluid communication with the discharge conduit 140 such that during operation of the suction source 150 (which may be always running, periodically running on a duty cycle, running for a set period of time after the presence of a refrigerant within the inner volume B is sensed, running after the presence of a refrigerant within the inner volume B is sensed and until the refrigerant is no longer sensed (i.e. immediately stopping after the refrigerant is no longer sensed or running for a set period of time after the refrigerant is no longer sensed or operated as called for by the controller 1000)) a negative pressure (suction) is formed upstream of the suction source 150 (e.g. within the portion 141) of the discharge conduit 140 between the connection 140 and the suction source 150, which is communicated into the inner volume B.

The suction source 150 may be an component that is configured to propel flow through and out of the discharge conduit 140 (flow WW) and draw a suction from the inner volume B (flow ZZ), which may flow from one of the channels 162 (discussed below) or from the inner volume B itself. In some embodiments the suction source 150 may be blower or a fan that is configured to intake (take suction) from the discharge conduit 140 (and specifically from portion 141 of the discharge conduit 140 that connects the suction source to the connection 139) and expel liquid or gas (or refrigerant such as propane) that flows into the blower through the discharge portion 142 of the discharge conduit 140. Alternatively, the suction source 150 may be a vacuum pump, or an air handling unit (particularly one that is also adapted to be able to accept liquid therethrough). One of ordinary skill in the art with a thorough review and understanding of this disclosure will be able to select an appropriate suction source 150 with merely routine optimization.

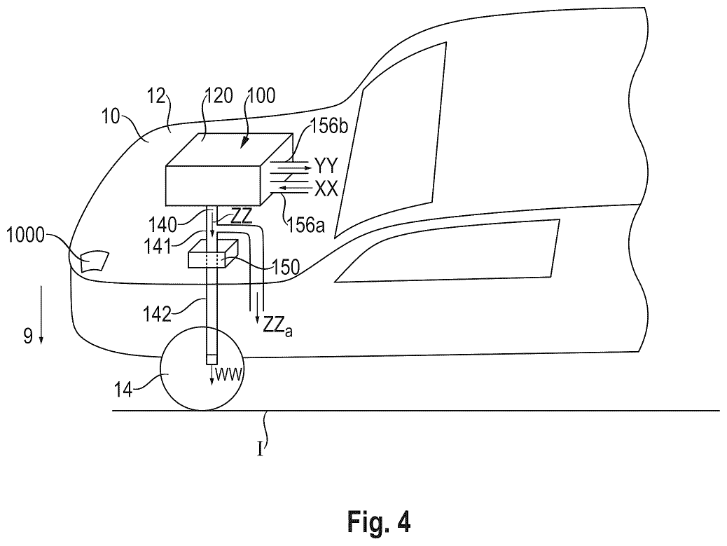

In some embodiments, the discharge portion 142 downstream of the suction source 150 may form two separate paths 142a, 142b that direct flow to different locations within the vehicle (respective flows WWa, WWb through paths 142a, 142b) such that the system will continue to evacuate liquid (or refrigerant such as propane) from the inner volume B within the enclosure 120 should one of the two paths 142a, 142 b become blocked. Similarly, a second drain line 143 that travels from the connection 139 and bypasses the section source 150 may be provided to allow for drainage (ZZa) from the enclosure 120 should the suction source 150 become inoperative or the path 141, 142 become blocked or fouled, with the second drain line 143 draining to a second and different location within the vehicle as depicted in FIG. 4. In some embodiments as depicted in FIG. 2 the second drain line 143 may branch off of the portion 141 just downstream of the connection 139, such that flows through each of the suction source 150 and the second drain line 143 flows through the connection 139. In other embodiments, the second drain line 143 connects to the enclosure 120 (preferably to a bottom wall 124 thereof) at a different location 139b than the location of the connection 139, as depicted in FIG. 2A. The drain line(s) may extend out of the vehicle, such as through an aperture within the floor of the vehicle or through an opening in the mechanical space within the vehicle, such that flow from the drain line is released to the environment.

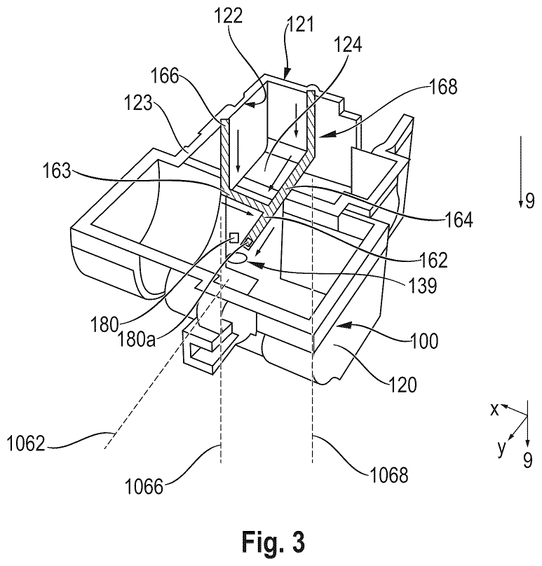

As depicted in FIGS. 2 and 3, the enclosure 120 may be formed from outer walls 121 that surround the components of the thermal management module 110. The term surrounds means completely surrounding the entirety of and all components of the thermal management module 110 and also includes partially surrounding, such as surrounding a majority of the thermal management, including a majority of the components of the thermal management module. The walls include an inner surface 122 that contacts portions of the thermal management module 110 and are form the boundaries that define the inner volume B. In some embodiments, one or more of the walls 121 are formed such that the inner surface 122 along the respective wall includes a flow channel defined therein that establishes a path for liquid (including a liquid, a fluid, or refrigerant, such as propone, that is heavier than ambient air) that contacts the respective flow path to flow therealong and toward and ultimately to the connection 139 to allow the liquid (or propane) to flow into the discharge conduit 140. As depicted in FIG. 3 (and, schematically in FIG. 2) in a preferred embodiment, one or more side walls 123 include channels 166, 168, and a bottom wall 124 includes a channel 163, 164, 162. The channels may be formed with a curved cross-section into the thickness of the wall (such that the flow channels are formed monolithically with one or more walls that establish the enclosure or the flow channels (e.g. with the channels being formed as the parts that form the walls are formed or the flow channels machined into the surface of the walls)), with the curved cross-section configured to capture liquid (or refrigerant such as propane) that flows along the wall and direct the flow through the channel either to one of channels 164, 162 (or the channel 162) upon the bottom wall 124 that leads to the connection 139, specifically at or in very close proximity to the connection 139. The channels are preferably established to direct liquid (or refrigerant such as propane) flow therethrough and ultimately to the connection due to the force of gravity. The side walls 123 may be arranged vertically, or may have various orientations along their length but ultimately extend between the bottom wall 124 and a top wall 125 of the enclosure, and therefore have portions that extend vertically or at least in directions with vector components that extend along a tangent of the wall that are vertical (i.e. parallel to the direction of gravity—g).

As depicted in FIGS. 3 and 4, the system 100 is fixed within the vehicle 10 in a predetermined orientation with respect to the direction of the force of gravity (arrow g, FIGS. 2-4), which as is well understood by one of ordinary skill in the art with a thorough review of this specification will urge liquid (or refrigerant such as propane) to flow in the direction of the force of gravity. The channels 166, 168 along the side walls 123 extend in a vertical direction, or in a direction with a vector component that is in the vertical direction (parallel to the direction of the force of gravity) to urge liquid (or refrigerant such as propane) to flow along the channel. The channels 166, 168 along the side walls transition to respective channels along the bottom wall 124, and the channels encourage liquid (or refrigerant such as propane) to flow vertically downward within the enclosure (flow QQ, RR). Liquid that condenses upon the surfaces of the thermal management module 110 may also drip, flow, or fall vertically downwardly within inner volume (flow P). The channels along the bottom wall 124 are preferably formed with a slope, such that they extend along their length in a direction that has a vector component that is parallel to the direction of the force of gravity (g) to prevent liquid (or refrigerant such as propane)from resting or pooling within the respective channel and instead directs the liquid (or refrigerant such as propane) that flows within the channel toward the connection 139 and into the discharge conduit 140, but also extends with a horizontal vector component (i.e. a vector component perpendicular to the direction of gravity, g). Typically, the magnitude of the horizontal vector component of the channels 162, 163, 164 along the bottom wall 124 will be larger than the magnitude of the vertical vector component of along the respective channel.

In the embodiment depicted in FIGS. 2 and 3, a channel 166 along a side wall 123 extends to a channel 163 along the bottom wall, and a channel 166 along a different portion of the side wall 123 extends to a channel 164 along a different portion of the bottom wall. Both channels 164 and 163 extend to a channel 162 that extends along the bottom wall 124 to the connection 139. One of ordinary skill in the art with a thorough review and understanding of this specification and figures would be able to position an appropriate number of channels within the enclosure to allow for anticipated worst case liquid (or refrigerant such as propane) within the enclosure to properly drain toward the connection 139 and into the discharge conduit 140. One of ordinary skill in the art with a thorough review and understanding of this specification and figures would be able to properly align each channel (and specifically the relationship between the channels within the side wall 123 and the channels within the bottom wall 124 to cause the liquid (or refrigerant such as propane) that flows into a respective channel (at any location along each channel) to ultimately flow to the connection 139. The use of the term “the liquid” herein and throughout this application means substantially all liquid and accounts for some residual liquid that may remain upon the surface of the channel due to surface friction (or other fluid flow phenomena inherent to the properties of the liquid and the material that forms the respective walls 123, 124 of the enclosure 120) or other forces that would maintain the surface of the channel “wet” after the liquid flows along the respective channel, and specifically includes refrigerants that may be in gaseous or fluid states such as propane. Alternatively, the refrigerant (such as propane as described below) may be received within the respective channel and may flow along the respective channel(s). The embodiment of FIG. 1 may also include the channels on the side walls and bottom wall as described above.

In some embodiments the side walls 123, especially in positions were it is foreseeable/likely that refrigerant may leak from the thermal management module 110 thereon due to the position of the thermal management module 110 within the enclosure (or that condensed water may reach during thermal management module 110), may be oriented to direct the refrigerant downward along the side wall and toward the bottom wall 124, at positions that do not include specifically formed flow channels 166, 168. Similarly, the bottom wall 124 at positions where it is foreseeable to received refrigerant (such as propane as discussed below) (or condensed water) thereon (either directly or that flows downwardly from the neighboring portion of the side wall 123) may be formed to direct that refrigerant or liquid toward a channel 162, 163, 164 or directly toward the connection 139.

In an embodiment depicted in FIG. 2 depicts and arrangement where the discharge conduit 140 extends downwardly from the connection 139. In some embodiments, the discharge conduit 140, and specifically the portion 141 between the connection 139 and the suction source 150 may extend in parallel to the direction of the force of gravity (g), while in other embodiments, the discharge conduit may extend in a direction that has a vector component that is parallel to the direction of the force of gravity and also has a vector component that is perpendicular to the force of gravity (that extends in the X or Y directions (FIG. 3), that are each perpendicular to the direction of the force of gravity (and X and Y are perpendicular to each other) or in a combination of the X and Y directions. In this embodiment, the magnitude of the vector component parallel to the direction of the force of gravity (g) would be significantly greater than the magnitude of the vector component that is perpendicular to the direction of the force of gravity (g). For example, the discharge conduit 140 (particularly the portion 141, and in some embodiments, the portion 142 downstream of the discharge of the suction source 150) may extend a small acute angle away from the direction of the force of gravity—such as between 0 and 30 degrees (inclusive of all angles within this range) away from the direction of the force of gravity (g). In some embodiments, the portion 142 of the discharge conduit 140 downstream of the suction source 150 may extend at a different angle (or angles if curved) with respect to the direction of the force of gravity (g). In some embodiments the portion 142 may include sections that extend along a direction with a vector component that is opposite to the direction of the force of gravity (g), to allow the portion to 142 be aligned as desired with respect to other components within the vehicle 10 for spacing reasons related to the desired construction of the vehicle.

The portion 142 of the discharge conduit 140 preferably extends to an end that directs fluid flowing therethrough out of the vehicle 10, such as onto the surface (1) that the vehicle 10 is resting upon, or to a side of the vehicle. The end of the portion 142 may be within or proximate to a wheel well (area that surrounds wheel 14) or below other portions of the vehicle 10.

The system 10 is configured to receive refrigerant (such as propane or other refrigerants) that leak out of a refrigeration system associated with the thermal management module 110 and enter the inner volume B within the enclosure 120. Propane is a 2-phase fluid or only gas at atmospheric pressure but it is heavier than ambient air and therefore it will fall and be guided by channels similar to a liquid at a slow velocity. The propane that leaks into the inner volume B would typically flow onto the side walls 123 or bottom wall 124 within the enclosure. In preferred embodiments, the channels (162, 163, 164, 166, 168) would be positioned upon the respective side walls or bottom wall 123, 124 at positions where it is anticipated that propane might have a higher chance of leaking from the refrigeration system, as would be readily understood by one of ordinary skill in the art of the development of thermal management modules and with an understanding of this specification and figures. Similarly, it is preferred that the dedicated openings 129 (when provided) within the enclosure 120 be provided at locations and positions where it is unlikely that refrigerant (such as propane as discussed above) would contact should refrigerant leak from the thermal management module 110. For example, dedicated openings 129 may be relatively high along the side wall 123 of the enclosure, and facing a position in the thermal management module where refrigerant does not flow, or there is no refrigerant line or connection in the proximity or direction of the dedicated opening 129.

In some embodiments, a sensor 180 may be provided that is configured to sense the presence of a refrigerant that has leaked from the thermal management module 110. The sensor 180 may be disposed within the enclosure 120 (specifically within the inner volume B of the enclosure 120) or may be positioned outside of the enclosure. In some embodiments, the sensor 180 is proximate to the connection 139 and in some embodiments, directly senses for the presence of refrigerant within a channel, such as preferably within the channel 162 along the bottom wall 124 proximate to the connection 139 (e.g. sensor 180a, FIG. 3). The sensor 180 sends a signal to a controller 1000 (FIG. 4, schematic) that controls the operation of the suction source 150, and may also control other features, such as the thermal management module 110, or other components within the vehicle 10. In some embodiments, the controller 1000 may be configured to start the suction source 150 if the sensor 180 detects the presence of a refrigerant at the sensed location, and then operates the suction source 150 in a programmed manner, as discussed above. As discussed above, the controller 1000 may also control the operation of the suction source 150 based upon the sensed, understood, or programmed operation of the thermal management module 110. For example, one of ordinary skill in the art would understand the typical amount of liquid that would condense within the enclosure 120 based upon specific heat loads upon the thermal management module 110, particularly at given ambient temperatures or given ambient humidities (or at sensed or expected temperature within the inner volume B), and the controller 1000 would be programmed by one of ordinary skill with a thorough review of this specification to operate with a needed duty cycle to remove the anticipated condensed liquid within the inner volume B based upon those measured conditions.

In other embodiments, the sensor 180 may alternatively, or additionally detect the presence of other liquids, such as water, and direct the operation of the suction source 150 to cause the sensed liquid to be removed from the inner volume B (due to the suction force, partial vacuum) that flows into the inner volume B via the channel discharge channel 141 when the suction source 150 is operating.

The term “about” is specifically defined herein to include a range that includes the reference value and plus or minus 5% of the reference value. The term “substantially the same” is when the item under comparison is within 5% of the aspect of the reference value of the item. The term “substantially” is when the referenced value or referenced aspect is within 5% of the reference value. For example, if the referenced item is an angle, something is substantially at that angle if it is within plus or minus 5% of the angle. The term “substantially” referenced with respect to a state (e.g. a path being substantially blocked) means that referenced state is blocked but may allow for di minimus flow therepast. The term “substantially” is when the term under comparison is not the exact same item (such as shape or length) as mentioned but with only di minimus changes from the referenced item as those di minimus changes would be appreciated by one or ordinary skill in the art, such as changes that do not significantly affect the structure or function of the item. The term “support” may be direct support (i.e. one item is directly supported by another other item—typically with contact therebetween) as well as indirect support (i.e. one item supports another item due to an intervening member that is typically on contact with both items and the supporting force is transferred through the intervening member).

The computing elements or functions disclosed herein (such as the controller 1000) may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification can be readily understood with reference to the following Numbered Paragraphs:

Numbered Paragraph 1: A thermal management module system, comprising:
a thermal management module and an enclosure that surrounds the thermal management module,
wherein the enclosure comprises a connection for a drainage path that leads from a space within the enclosure, and a discharge conduit that is fluidly connected to the connection and extends away from the enclosure, wherein the connection is arranged such that liquid that exists outside of the thermal management module and within the enclosure can flow through the connection;
further comprising a suction source that is disposed in communication with the discharge conduit.

Numbered Paragraph 2: The thermal management module system of Numbered Paragraph 1, wherein the suction source through the connection is a vacuum pump.

Numbered Paragraph 3: The thermal management module system of Numbered Paragraph 1, wherein the suction source through the connection is a blower that draws suction from the discharge conduit.

Numbered Paragraph 4: The thermal management module system of any one of the preceding Numbered Paragraphs, wherein the enclosure is configured to allow some air flow therethrough to provide air to flow through the connection and the discharge conduit.

Numbered Paragraph 5: The thermal management module system of any one of the Preceding Numbered Paragraphs, wherein the enclosure includes one or more walls that are disposed to surround the thermal management module, wherein the one or more walls includes an inner surface that is disposed in a direction that faces and/or contacts one or more components of the thermal management module, wherein the inner surface of the one or more walls comprises a flow channel defined therein that directs liquid to flow along the flow channel and toward the connection, wherein the flow channel directs liquid to flow along the flow channel and toward the connection due to the force of gravity.

Numbered Paragraph 6: The thermal management module system of Numbered Paragraph 5, wherein the flow channel comprises first and second flow channels that are disposed at differing positions upon the one or more walls.

Numbered Paragraph 7: The thermal management module system of Numbered Paragraph 6, wherein the flow channel further comprises a third flow channel that is disposed with an end thereof that is at or very closely proximate to the connection.

Numbered Paragraph 8: The thermal management module system of Numbered Paragraph 6, wherein the first and second flow channels are disposed upon the one or more walls such that flow therethrough flows with a vector component that extends parallel to a direction that the force of gravity acts upon the system when the thermal management module system is installed within a vehicle.

Numbered Paragraph 9: The thermal management module system of Numbered Paragraph 8, further comprising a third flow channel that is disposed with an end thereof that is at or very closely proximate to the connection, wherein the first and second flow channels each are connected to the third flow channel such that the liquid that flows through one of the first or second flow channels flows into the third flow channel and flows through the third flow channel to the connection.

Numbered Paragraph 10: The thermal management module system of Numbered Paragraph 9, wherein the third flow channel is disposed along a direction with a horizontal vector component that extends perpendicular to the direction that the force of gravity acts upon the system when the thermal management module system is installed within the vehicle.

Numbered Paragraph 11: The thermal management module system of Numbered Paragraph 10, wherein at least a portion of the third flow channel is disposed with a vertical vector component that extends parallel to the direction that the force of gravity acts upon the system when the thermal management module system is installed within the vehicle, wherein a magnitude of the horizontal vector component is larger than a magnitude of the vertical vector component.

Numbered Paragraph 12: The thermal management module system of any one of the preceding Numbered Paragraphs, wherein the discharge conduit is disposed such that a portion of the discharge conduit that directly extends from the connection extends in a direction with a vertical vector component.

Numbered Paragraph 13: The thermal management module system of Numbered Paragraph 10, wherein the one or more walls are configured to direct refrigerant that is heavier than ambient air that contacts the one or more walls to flow toward and into the third flow channel, such that refrigerant that is heavier than ambient air flows to the connection and through the discharge conduit.

Numbered Paragraph 14: The thermal management module system of any one of the preceding Numbered Paragraphs, wherein the discharge conduit includes a second end that is downstream of the suction source, wherein the second end extends to an exterior position of the vehicle that directs liquid flowing out of the second end toward a surface that the vehicle is disposed upon.

Numbered Paragraph 15: A thermal management module system, comprising:
a thermal management module and an enclosure that surrounds the thermal management module,
wherein the enclosure comprises a connection for a drainage path that leads from a space within the enclosure, wherein the connection is arranged such that a liquid, or fluid, or refrigerant that is heavier than ambient air that exists outside of the thermal management module and within the enclosure can flow through the connection,

Numbered Paragraph 16: The thermal management module system of Numbered Paragraph 15, wherein the connection is disposed within a portion that is at or proximate to a geometric center of the enclosure and upon a bottom surface of the enclosure when the enclosure is installed within a vehicle

Numbered Paragraph 17: The thermal management module system of either one of Numbered Paragraphs 15 or 16, wherein the enclosure is configured to allow some air flow therethrough to provide air to flow through the connection.

Numbered Paragraph 18: The thermal management module system of any one of Numbered Paragraphs 15-17, wherein the enclosure includes one or more walls that are disposed to surround the thermal management module, wherein the one or more walls includes an inner surface that is disposed in a direction that faces and/or contacts one or more components of the thermal management module, wherein the inner surface of the one or more walls comprises a flow channel defined therein that directs liquid, or fluid, or refrigerant that is heavier than ambient air to flow along the flow channel and toward the connection, wherein the flow channel directs liquid, or fluid, or refrigerant that is heavier than ambient air to flow along the flow channel and toward the connection due to the force of gravity.

Numbered Paragraph 19: The thermal management module of Numbered Paragraph 18, wherein the flow channel is disposed monolithically within the one or more walls of the enclosure.

Numbered Paragraph 20: The thermal management module system of Numbered Paragraph 19, wherein the flow channel comprises first and second flow channels that are disposed at differing positions upon the one or more walls.

Numbered Paragraph 21: The thermal management module system of Numbered Paragraph 20, wherein the flow channel further comprises a third flow channel that is disposed with an end thereof that is at or very closely proximate to the connection.

Numbered Paragraph 22: The thermal management module system of Numbered Paragraph 19, wherein the flow channel further comprises second flow channel that is disposed with an end thereof that is at or very closely proximate to the connection.

Numbered Paragraph 23: The thermal management module system of Numbered Paragraph 20, wherein the first and second flow channels are disposed upon the one or more walls such that flow therethrough flows with a vector component that extends parallel to a direction that the force of gravity acts upon the system when the thermal management module system is installed within a vehicle.

Numbered Paragraph 24: The thermal management module system of Numbered Paragraph 23, further comprising a third flow channel that is disposed with an end thereof that is at or very closely proximate to the connection, wherein the first and second flow channels each are connected to the third flow channel such that the liquid, or fluid, or refrigerant that is heavier than ambient air that flows through one of the first or second flow channels flows into the third flow channel and flows through the third flow channel to the connection.

Numbered Paragraph 25: The thermal management module system of Numbered Paragraph 24, wherein the third flow channel is disposed along a direction with a horizontal vector component that extends perpendicular to the direction that the force of gravity acts upon the system when the thermal management module system is installed within the vehicle.

Numbered Paragraph 26: The thermal management module system of Numbered Paragraph 25, wherein at least a portion of the third flow channel is disposed with a vertical vector component that extends parallel to the direction that the force of gravity acts upon the system when the thermal management module system is installed within the vehicle, wherein a magnitude of the horizontal vector component is larger than a magnitude of the vertical vector component.

Numbered Paragraph 27: The thermal management module system of any oe of Numbered Paragraphs 15-26, further comprising a discharge conduit that is fluidly connected to the connection and is disposed such that a portion of the discharge conduit that directly extends from the connection extends in a direction with a vertical vector component.

Numbered Paragraph 28: The thermal management module system of Numbered Paragraph 27, wherein the one or more walls are configured to direct refrigerant that is heavier than ambient air that contacts the one or more walls to flow toward and into the third flow channel, such that the refrigerant that is heavier than ambient air flows to the connection and through the discharge conduit toward a surface that the vehicle is disposed on or to a side of the vehicle.

Numbered Paragraph 29: The thermal management module system of either one of Numbered Paragraphs 27 or 28, wherein the discharge conduit includes a second end that is downstream of a suction source connected therewith, wherein the second end extends to an exterior position of the vehicle that directs liquid, or fluid, or refrigerant that is heavier than ambient air flowing out of the second end toward a surface that the vehicle is disposed upon or to a side of the vehicle.

Numbered Paragraph 30: The thermal management module system of any one of Numbered Paragraphs 27-29, wherein the discharge conduit is first and second independent discharge conduits, and wherein the connection is respective first and second independent connections with the first discharge conduit extending from the first connection and the second discharge conduit extending from the second connection, the first and second connections are disposed upon different locations of the enclosure such that a blockage of one of the first and second connections that prevents or minimizes flow from the enclosure through the respect first or second connection does not prevent or minimize flow from the enclosure through the other of the first or second connection.

Numbered Paragraph 31: The thermal management module system of Numbered Paragraph 30, wherein at least one of the first and second independent discharge conduits includes a second end that is connected therewith, wherein the second end extends to an exterior position of the vehicle that directs liquid, or fluid, or refrigerant that is heavier than ambient air flowing out of the second end toward a surface that the vehicle is disposed upon or to a side of the vehicle.

Numbered Paragraph 32: A thermal management module system, comprising:
a thermal management module and an enclosure that surrounds the thermal management module,
wherein the enclosure comprises a connection for a drainage path that leads from a space within the enclosure, and a discharge conduit that is fluidly connected to the connection and extends away from the enclosure, wherein the connection is arranged such that liquid, or fluid, or refrigerant that is heavier than ambient air that exists outside of the thermal management module and within the enclosure can flow through the connection;
wherein the enclosure includes one or more walls that are disposed to surround the thermal management module, wherein the one or more walls includes an inner surface that is disposed in a direction that faces and/or contacts one or more components of the thermal management module, wherein the inner surface of the one or more walls comprises a flow channel defined therein that directs liquid, or fluid, or refrigerant that is heavier than ambient air to flow along the flow channel and toward the connection, wherein the flow channel directs liquid, or fluid, or refrigerant that is heavier than ambient air to flow along the flow channel and toward the connection due to the force of gravity, wherein the flow channel is disposed monolithically within the one or more walls of the enclosure,
further comprising a suction source that is disposed in communication with the discharge conduit.

Numbered Paragraph 33: The thermal management module system of Numbered Paragraph 32, wherein the enclosure is configured to allow some air flow therethrough to provide air to flow through the connection and the discharge conduit.

Numbered Paragraph 34: The thermal management module system of either one of Numbered Paragraphs 32 or 33, wherein the flow channel comprises first and second flow channels that are disposed at differing positions upon the one or more walls.

Numbered Paragraph 35: The thermal management module system of Numbered Paragraph 34, wherein the flow channel further comprises a third flow channel that is disposed with an end thereof that is at or very closely proximate to the connection.

Numbered Paragraph 36: The thermal management module system of Numbered Paragraph 35, wherein the first and second flow channels are disposed upon the one or more walls such that flow therethrough flows with a vector component that extends parallel to a direction that the force of gravity acts upon the system when the thermal management module system is installed within a vehicle.

Numbered Paragraph 37: The thermal management module system of Numbered Paragraph 36, further comprising a third flow channel that is disposed with an end thereof that is at or very closely proximate to the connection, wherein the first and second flow channels each are connected to the third flow channel such that the liquid, or fluid, or refrigerant that is heavier than ambient air that flows through one of the first or second flow channels flows into the third flow channel and flows through the third flow channel to the connection.

Numbered Paragraph 38: The thermal management module system of Numbered Paragraph 37, wherein the third flow channel is disposed along a direction with a horizontal vector component that extends perpendicular to the direction that the force of gravity acts upon the system when the thermal management module system is installed within the vehicle.

Numbered Paragraph 39: The thermal management module system of Numbered Paragraph 38, wherein at least a portion of the third flow channel is disposed with a vertical vector component that extends parallel to the direction that the force of gravity acts upon the system when the thermal management module system is installed within the vehicle, wherein a magnitude of the horizontal vector component is larger than a magnitude of the vertical vector component.

Numbered Paragraph 40: The thermal management module system of Numbered Paragraph 39, wherein the discharge conduit is disposed such that a portion of the discharge conduit that directly extends from the connection extends in a direction with a vertical vector component.

Numbered Paragraph 41: The thermal management module system of any one of Numbered Paragraphs 38-40, wherein the one or more walls are configured to direct refrigerant that is heavier than ambient air that contacts the one or more walls to flow toward and into the third flow channel, such that the refrigerant that is heavier than ambient air flows to the connection and through the discharge conduit.

Numbered Paragraph 42: The thermal management module system of any one of Numbered Paragraphs 32-41, wherein the discharge conduit includes a second end that is downstream of the suction source, wherein the second end extends to an exterior position of the vehicle that directs liquid, or fluid, or refrigerant that is heavier than ambient air flowing out of the second end toward a surface that the vehicle is disposed upon.

Numbered Paragraph 43: The thermal management module system of any one of Numbered Paragraphs 32-42, wherein the discharge conduit is first and second independent discharge conduits, and wherein the connection is respective first and second independent connections with the first discharge conduit extending from the first connection and the second discharge conduit extending from the second connection, the first and second connections are disposed upon different locations of the enclosure such that a blockage of one of the first and second connections that prevents or minimizes flow from the enclosure through the respect first or second connection does not prevent or minimize flow from the enclosure through the other of the first or second connection.

1. A thermal management module system, comprising:
a thermal management module and an enclosure that surrounds the thermal management module,
wherein the enclosure comprises a connection for a drainage path that leads from a space within the enclosure, wherein the connection is arranged such that a liquid, or fluid, or refrigerant that is heavier than ambient air that exists outside of the thermal management module and within the enclosure can flow through the connection

2. The thermal management module system of claim 1, wherein the connection is disposed within a portion that is at or proximate to a geometric center of the enclosure and upon a bottom surface of the enclosure when the enclosure is installed within a vehicle

3. The thermal management module system of claim 1, wherein the enclosure is configured to allow some air flow therethrough to provide air to flow through the connection.

4. The thermal management module system of claim 1, wherein the enclosure includes one or more walls that are disposed to surround the thermal management module, wherein the one or more walls includes an inner surface that is disposed in a direction that faces and/or contacts one or more components of the thermal management module, wherein the inner surface of the one or more walls comprises a flow channel defined therein that directs liquid, or fluid, or refrigerant that is heavier than ambient air to flow along the flow channel and toward the connection, wherein the flow channel directs liquid, or fluid, or refrigerant that is heavier than ambient air to flow along the flow channel and toward the connection due to the force of gravity.

5. The thermal management module of claim 4, wherein the flow channel is disposed monolithically within the one or more walls of the enclosure.

6. The thermal management module system of claim 5, wherein the flow channel comprises first and second flow channels that are disposed at differing positions upon the one or more walls.

7. The thermal management module system of claim 6, wherein the flow channel further comprises a third flow channel that is disposed with an end thereof that is at or very closely proximate to the connection.

8. The thermal management module system of claim 5, wherein the flow channel further comprises second flow channel that is disposed with an end thereof that is at or very closely proximate to the connection.

9. The thermal management module system of claim 6, wherein the first and second flow channels are disposed upon the one or more walls such that flow therethrough flows with a vector component that extends parallel to a direction that the force of gravity acts upon the system when the thermal management module system is installed within a vehicle.

10. The thermal management module system of claim 9, further comprising a third flow channel that is disposed with an end thereof that is at or very closely proximate to the connection, wherein the first and second flow channels each are connected to the third flow channel such that the liquid, or fluid, or refrigerant that is heavier than ambient air that flows through one of the first or second flow channels flows into the third flow channel and flows through the third flow channel to the connection.

11. The thermal management module system of claim 10, wherein the third flow channel is disposed along a direction with a horizontal vector component that extends perpendicular to the direction that the force of gravity acts upon the system when the thermal management module system is installed within the vehicle.

12. The thermal management module system of claim 11, wherein at least a portion of the third flow channel is disposed with a vertical vector component that extends parallel to the direction that the force of gravity acts upon the system when the thermal management module system is installed within the vehicle, wherein a magnitude of the horizontal vector component is larger than a magnitude of the vertical vector component.

13. The thermal management module system of claim 1, further comprising a discharge conduit that is fluidly connected to the connection and is disposed such that a portion of the discharge conduit that directly extends from the connection extends in a direction with a vertical vector component.

14. The thermal management module system of claim 13, wherein the one or more walls are configured to direct refrigerant that is heavier than ambient air that contacts the one or more walls to flow toward and into the third flow channel, such that the refrigerant that is heavier than ambient air flows to the connection and through the discharge conduit toward a surface that the vehicle is disposed on or to a side of the vehicle.

15. The thermal management module system of claim 13, wherein the discharge conduit includes a second end, wherein the second end extends to an exterior position of the vehicle that directs liquid, or fluid, or refrigerant that is heavier than ambient air flowing out of the second end toward a surface that the vehicle is disposed upon or to a side of the vehicle.

16. The thermal management module system of claim 13, wherein the discharge conduit is first and second independent discharge conduits, and wherein the connection is respective first and second independent connections with the first discharge conduit extending from the first connection and the second discharge conduit extending from the second connection, the first and second connections are disposed upon different locations of the enclosure such that a blockage of one of the first and second connections that prevents or minimizes flow from the enclosure through the respect first or second connection does not prevent or minimize flow from the enclosure through the other of the first or second connection.

17. The thermal management module system of claim 16, wherein at least one of the first and second independent discharge conduits includes a second end that is connected therewith, wherein the second end extends to an exterior position of the vehicle that directs liquid, or fluid, or refrigerant that is heavier than ambient air flowing out of the second end toward a surface that the vehicle is disposed upon or to a side of the vehicle.

18. A thermal management module system, comprising:
a thermal management module and an enclosure that surrounds the thermal management module,
wherein the enclosure comprises a connection for a drainage path that leads from a space within the enclosure, and a discharge conduit that is fluidly connected to the connection and extends away from the enclosure, wherein the connection is arranged such that liquid, or fluid, or refrigerant that is heavier than ambient air that exists outside of the thermal management module and within the enclosure can flow through the connection;
wherein the enclosure includes one or more walls that are disposed to surround the thermal management module, wherein the one or more walls includes an inner surface that is disposed in a direction that faces and/or contacts one or more components of the thermal management module, wherein the inner surface of the one or more walls comprises a flow channel defined therein that directs liquid, or fluid, or refrigerant that is heavier than ambient air to flow along the flow channel and toward the connection, wherein the flow channel directs liquid, or fluid, or refrigerant that is heavier than ambient air to flow along the flow channel and toward the connection due to the force of gravity, wherein the flow channel is disposed monolithically within the one or more walls of the enclosure,
further comprising a suction source that is disposed in communication with the discharge conduit.

19. The thermal management module system of claim 18, wherein the enclosure is configured to allow some air flow therethrough to provide air to flow through the connection and the discharge conduit.

20. The thermal management module system of claim 18, wherein the flow channel comprises first and second flow channels that are disposed at differing positions upon the one or more walls.

21. The thermal management module system of claim 20, wherein the flow channel further comprises a third flow channel that is disposed with an end thereof that is at or very closely proximate to the connection.

22. The thermal management module system of claim 21, wherein the first and second flow channels are disposed upon the one or more walls such that flow therethrough flows with a vector component that extends parallel to a direction that the force of gravity acts upon the system when the thermal management module system is installed within a vehicle.

23. The thermal management module system of claim 22, further comprising a third flow channel that is disposed with an end thereof that is at or very closely proximate to the connection, wherein the first and second flow channels each are connected to the third flow channel such that the liquid, or fluid, or refrigerant that is heavier than ambient air that flows through one of the first or second flow channels flows into the third flow channel and flows through the third flow channel to the connection.

24. The thermal management module system of claim 23, wherein the third flow channel is disposed along a direction with a horizontal vector component that extends perpendicular to the direction that the force of gravity acts upon the system when the thermal management module system is installed within the vehicle.

25. The thermal management module system of claim 24, wherein at least a portion of the third flow channel is disposed with a vertical vector component that extends parallel to the direction that the force of gravity acts upon the system when the thermal management module system is installed within the vehicle, wherein a magnitude of the horizontal vector component is larger than a magnitude of the vertical vector component.

26. The thermal management module system of claim 18, wherein the discharge conduit is disposed such that a portion of the discharge conduit that directly extends from the connection extends in a direction with a vertical vector component.

27. The thermal management module system of claim 24, wherein the one or more walls are configured to direct refrigerant that is heavier than ambient air that contacts the one or more walls to flow toward and into the third flow channel, such that the refrigerant that is heavier than ambient air flows to the connection and through the discharge conduit.

28. The thermal management module system of claim 18, wherein the discharge conduit includes a second end that is downstream of the suction source, wherein the second end extends to an exterior position of the vehicle that directs liquid, or fluid, or refrigerant that is heavier than ambient air flowing out of the second end toward a surface that the vehicle is disposed upon.

29. The thermal management module system of claim 18, wherein the discharge conduit is first and second independent discharge conduits, and wherein the connection is respective first and second independent connections with the first discharge conduit extending from the first connection and the second discharge conduit extending from the second connection, the first and second connections are disposed upon different locations of the enclosure such that a blockage of one of the first and second connections that prevents or minimizes flow from the enclosure through the respect first or second connection does not prevent or minimize flow from the enclosure through the other of the first or second connection.
